(19) United States
(12) Patent Application Publication
(10) Pub. No.: US 2013/0073620 A1
(43) Pub. Date: Mar. 21, 2013

(54) SYSTEM AND METHOD FOR ELECTRONIC TRADING BASED UPON INFLUENCE

(71) Applicant: Debashis GHOSH, Charlotte, NC (US)

(72) Inventor: Debashis GHOSH, Charlotte, NC (US)

(73) Assignee: IDIYAS, LLC, Charlotte, NC (US)

(21) Appl. No.: 13/235,676

(22) Filed: Sep. 19, 2011

(51) Int. Cl. G06F 15/16; G06F 17/30

(52) U.S. Cl. 709/204; 707/723; 707/E17.014

(57) ABSTRACT

The present invention provides methods and systems for electronic trading that includes providing a server and at least one user terminal that is coupled to the server. A first user having a first user profile and a plurality of second users having a plurality of second user profiles. The server accesses a social media platform of the first user with the at least one user terminal and calculates influence of the first user and provides a quantity of trading currency for use by the first user. The influence of the second user profiles are calculated and assigned a quantity of trading currency to the second user profiles based upon the calculated influence. The first user is able to buy shares of the second user profiles.

### FIELD OF THE INVENTION

The present invention relates generally to a system and method for electronic trading based upon influence and more specifically relates to a system and method for calculating influence using social media and allowing a user to electronically trade shares based upon influence, allowing a user to filter search results based upon influence, and allowing a user to interact with a seller in the marketplace based upon influence.

### BACKGROUND OF THE INVENTION

Social media is used by millions of people a day and is a fast growing enterprise. The individuals, entities, and companies engaged in the use of social media that have a large amount of influence garner the most followers or viewers of their social media profile. For example, a famous movie star may have over a million followers and a thoracic surgeon may only be followed by a few close friends and relatives. The famous movie star on the social media platform Twitter® will have many more followers than people she is following. Alternatively, the thoracic surgeon is probably following more people than are following her. This all means the movie star has much more influence than the thoracic surgeon.

The present invention assigns a value to the individuals, entities, and companies based upon the influence they possess. This is calculated generally based upon the number of followers versus the number of following. A quantity of shares are assigned based upon the calculated influence and other users may trade the shares. Additionally, the present invention incorporates a search platform that ranks the returns based upon the influence in a social media platform.

### BRIEF SUMMARY OF THE INVENTION

The present invention provides a method of electronic trading that includes providing a server and at least one user terminal that is coupled to the server, a first user having a first user profile and a plurality of second users having a plurality of second user profiles. The social media platform of the first user is accessed with the at least one user terminal, and the influence of the user is calculated and a quantity of trading currency for use by the first user is provided. The influence of the second user profiles is calculated and a quantity of trading currency is assigned to the second user profiles based upon the calculated influence. Shares of the second user profiles are bought by the first user.

According to another embodiment of the present invention, the present invention provides a method of electronic trading that includes providing a server and at least one user terminal that is coupled to the server, a first user having a first user profile and a plurality of second users having a plurality of second user profiles. A first search query is submitted for searching a first level database that yields high level aggregated classifications. High level aggregated classifications are obtained based upon the first search query. A second search query is submitted based upon the high level aggregated classifications of the first search query. The results of the second search query are ranked based upon the calculated influence and focused results are obtained based upon the second search query.

According to yet another embodiment of the present invention, the present invention provides a system for electronic trading based upon influence that includes a local interface, a data store, a server, at least one user terminal, and at least one user terminal that is coupled to the server. A first user has a first user profile and a plurality of second users have a plurality of second user profiles. A processor is coupled to the local interface, the data store, the server, and the at least one user terminal, wherein the processor is configured to access a social media platform of a first user with the at least one user terminal. Influence of the first user is calculated and a quantity of trading currency is provided for use by the first user. Influence of a plurality of second user profiles is calculated and a quantity of trading currency is assigned to the second user profiles based upon the calculated influence. Shares of the second user profiles are bought by the first user based upon the trading currency and the calculated influence.

### BRIEF DESCRIPTION OF THE DRAWINGS

The present invention is illustrated and described herein with reference to the various drawings, in which like reference numbers denote like method steps and/or system components, respectively, and in which:

FIG. 1 is a block diagram of a server system;

FIG. 2 is a screen shot of an exemplary home page;

FIG. 3 is a flow chart exemplifying the process a seller uses to list a good or service for sale; and

FIG. 4 is a flow chart exemplifying the process a buyer uses to inquire about a good or service they are interested in purchasing and the actual purchase of a product.

### DETAILED DESCRIPTION OF THE INVENTION

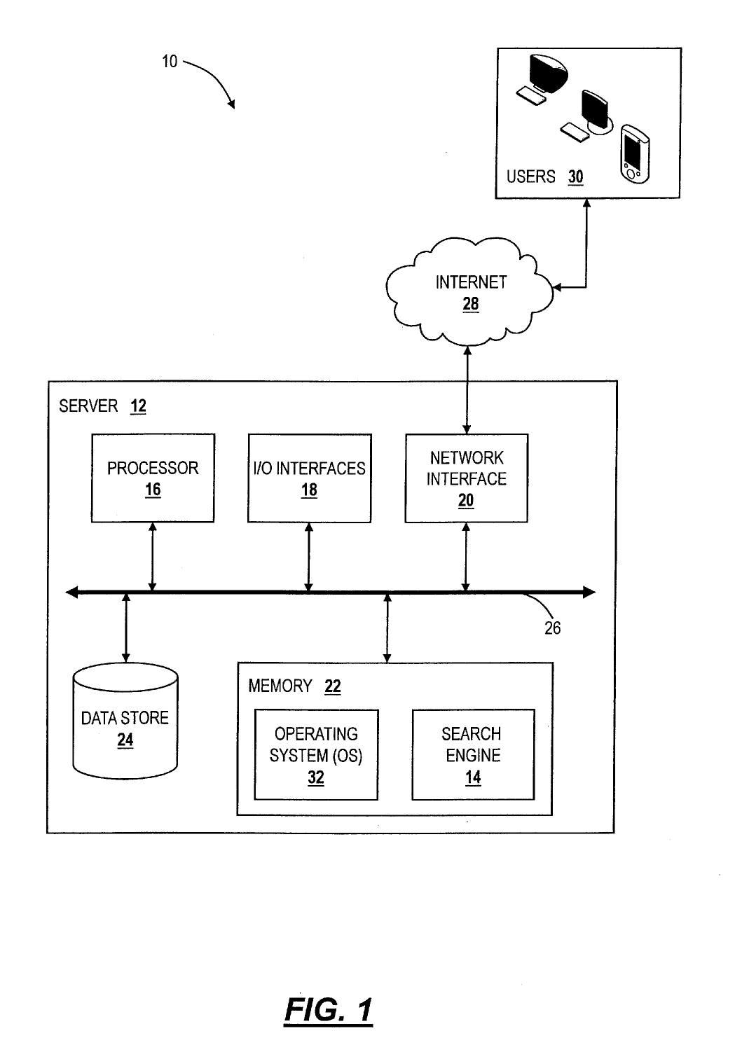

A system for electronic trading based upon influence and a system allowing a user to filter search results based upon influence is described herein. The system is shown generally at reference numeral 10. As illustrated in FIG. 1, the system includes a server 12 having a search engine 14, according to an exemplary embodiment of the present invention. The server 12 can be a digital computer that, in terms of hardware architecture, generally includes a processor 16, input/output (I/O) interfaces 18, a network interface 20, memory 22, and a data store 24. The components (16, 18, 20, 22, and 24) are communicatively coupled via a local interface 26. The local interface 26 can be, for example but not limited to, one or more buses or other wired or wireless connections, as is known in the art. The local interface 26 can have additional elements, which are omitted for simplicity, such as controllers, buffers (caches), drivers, repeaters, and receivers, among many others, to enable communications. Further, the local interface 26 can include address, control, and/or data connections to enable appropriate communications among the aforementioned components.

The processor 16 is a hardware device for executing software instructions. The processor 16 can be any custom made or commercially available processor, a central processing unit (CPU), an auxiliary processor among several processors associated with the server 12, a semiconductor-based microprocessor (in the form of a microchip or chip set), or generally any device for executing software instructions. When the server 12 is in operation, the processor 16 is configured to execute software stored within the memory 22, to communicate data to and from the memory 22, and to generally control operations of the server 12 pursuant to the software instructions.

The I/O interfaces 18 can be used to receive user input from and/or for providing system output to one or more devices or components. User input can be provided via, for example, a keyboard and/or a mouse. System output can be provided via a display device and a printer (not shown). I/O interfaces 18 can include, for example, a serial port, a parallel port, a small computer system interface (SCSI), an infrared (IR) interface, a radio frequency (RF) interface, and/or a universal serial bus (USB) interface.

The network interface 20 can be used to enable the server 12 to communicate on a network, such as the Internet 28. For example, the server 12 can utilize the network interface 20 to communicate to multiple users 30 over the Internet 28. The users 30 can include desktop computers connected to the Internet 28 via a high-speed connection (DSL, Cable modem, WiMax, Cellular, etc.), laptop computers connected to the Internet 28 via the high-speed connection, mobile devices connected to the Internet 28 via a mobile network, and the like. Each user 30 can also include a network interface to communicate to the server 12 to access the search engine 14. The network interface 20 can include, for example, an Ethernet card (e.g., 10BaseT, Fast Ethernet, Gigabit Ethernet) or a wireless local area network (WLAN) card (e.g., 802.11a/b/g). The network interface 20 can include address, control, and/or data connections to enable appropriate communications on the network.

A data store 24 can be used to store data, such as information for use with the search engine 14. The data store 24 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 24 can incorporate electronic, magnetic, optical, and/or other types of storage media. In one example, the data store 24 can be located internal to the server 12 such as, for example, an internal hard drive connected to the local interface 26 in the server 12. Additionally in another embodiment, the data store can be located external to the server 12 such as, for example, an external hard drive connected to the I/O interfaces 18 (e.g., SCSI or USB connection). Finally in a third embodiment, the data store 24 may be connected to the server 12 through a network, such as, for example, a network attached file server.

The memory 22 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 22 may incorporate electronic, magnetic, optical, and/or other types of storage media. Note that the memory 22 can have a distributed architecture, where various components are situated remotely from one another, but can be accessed by the processor 16.

The software in memory 22 can include one or more software programs, each of which includes an ordered listing of executable instructions for implementing logical functions. The software in the memory system 22 includes the adaptive gain control 14 engine and a suitable operating system (O/S) 32. The operating system 32 essentially controls the execution of other computer programs, such as the search engine 14, and provides scheduling, input-output control, file and data management, memory management, and communication control and related services. The operating system 28 can be any of Windows NT, Windows 2000, Windows XP, Windows Vista (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), or the like.

The system 10 is designed to be used by any number of individuals, i.e. the users 30. In one exemplary embodiment, the system 10 is designed for electronic trading based upon influence and a system allowing a user to filter search results based upon influence. The system 10 is fast, effective, and efficient.

The system 10 is designed to be used in conjunction with a social media platform. Social media platforms such as Twitter®, Facebook®, MySpace®, LinkedIn®, Instagram®, etc may be used in conjunction with the system 10. The system 10 is designed to be used in conjunction with these social media platforms and extract data from these platforms. For example only, and by no way meant to be a limitation, Twitter® very distinctively offers public information for each of its users. One source of information is the number of tweets the user has made, the number of followers the user has, and the number of entities or individuals the user is following. Each of these sources of information is quantifiable with a specific number.

For example, the user has a quantifiable number of followers. A follower is an individual or an entity using Twitter® that has elected to view the postings, or tweets, posted on the Twitter ® system by the user. A tweet is a text-based posting of up to 140 characters displayed on the user's profile page. Tweets can also contain a link to a webpage and allowing followers to click on the link and be directed to a webpage to find more information with regard to the tweet.

A user may tweet about many topics. A user may be a person that tweets about their day-to-day life or the user may be an entity, such as a new organization, that tweets about the news or the organization. A Twitter® user may elect to follow another user and clicks on a link to follow the user. Once this link is clicked, the user has an increase in the number of followers. The number of followers is a quantifiable number that is displayed prominently on the user's profile. The user who clicked the link to follow then has an additional quantifiable number for the users he/she is following.

The Twitter® social media platform is accessed over the Internet 28. The user accesses the Twitter® social media platform by logging into the Twitter® website. The network interface 20 can be used to enable the server 12 to communicate on the Internet 28. The server 12 may log into the users Twitter® account utilizing the user's username and password. The Twitter® open source program allows a third-party site to log into Twitter® using an individual's Twitter® username and password. Likewise, the system 10 of the present invention can log into the Twitter® site by using a registered user's username and password.

Once logged into Twitter®, the network interface 20 extracts pertinent data from the Twitter® site for use by the server 12. Specifically, the quantity of followers and the quantity of followers is quickly determined for not only the user but for the other user's of Twitter®. Thereafter, the system 10 through the sever 12 calculates the influence of each Twitter® user. The influence may be calculated as the difference between the number of followers and the number following, plus 10 times list and divided by a decay factor. T$ is calculated as follows:[(# followers−# following)+10×list]/decay factor

The decay factor is a factor based upon the last day the user posted on Twitter®. Preferably, the decay factor is based upon the last day the user posted on Twitter® over the last 90 days. For example, if the user posted within the last two days the decay factor would be calculated as (90−2)/90. By way of another example, if the user posted 90 days ago (or over 90 days and in this example any day over 90 days is still treated as 90 for calculating the decay factor), the decay factor would be calculated (90−90)/90.

The above formula is to be used as an example only. Influence may be calculated a number of different ways as is well known by one of ordinary skill in the art.

Influence may be based upon the equation set forth above. In other words, influence is created whenever the number of followers is greater than the number following plus 10 times list. The list is defined as the number of Twitter® lists containing this profile. This is positive influence, and like wealth, one has to work hard to earn it. Influence is defined on the system 10 as a Twittsdaq dollar (T$). In other words, the influence calculated by the system 10 is then assigned a number in monetary form and called a Twittsdaq dollar (T$). Each follower is assumed to be worth approximately T$0.01. It should be noted that the equation may be modified to depending upon the social media platform used. For example, the T$ formula may be modified based upon the data received from social media sites such as Facebook®, MySpace®, LinkedIn® , Instagram®, etc.

Shares are assigned to the users with the most influence. Not only do the users with the most influence have the highest Twittsdaq dollar amount, but they also have the highest number of shares that are able to be purchased. The user may use their Twittsdaq dollar (T$) to purchase shares of other users. The shares are then traded among users. As with any free market system, the more influence a person has the greater desire for a user to own a share, thus driving the cost of the shares higher. As the user buys and sells shares, assuming they sell the shares at a higher Twittsdaq dollar amount that what the shares were bought, the amount of Twittsdaq dollars obtained by the user increases.

Twittsdaq dollars may be obtained in two ways. First, the user may purchase Twittsdaq dollars for a predetermined price. Second, the user may participate in a daily challenge, which if won, could help the user gain followers, thus increasing their influence and gaining Twittsdaq dollars. To participate in the daily challenge, the user picks a user profile or user profiles and then trades these profiles. The winner of the daily challenge is the user that has accumulated the most Twittsdaq dollars from buying and selling shares of Twitter® profiles. The user profile of the winner of the daily challenge is posted in the home page, allowing other users to click the follow link of the winner and increasing the number of followers and increasing the influence. The Twittsdaq dollars may be exchanged for airline miles, bitcoin, or other equally sought after items.

The Twittsdaq dollars may be linked to real currency or to a peer-to-peer virtual currency, such as bitcoin (www.bitcoin.org). A user may purchase Twittsdaq dollars with U.S. or foreign currency and the user may receive U.S. or foreign currency upon the sale of shares. Likewise, a user may purchase Twittsdaw dollars with peer-to-peer virtual currency and the user may receive peer-to-peer virtual currency upon the sale of shares.

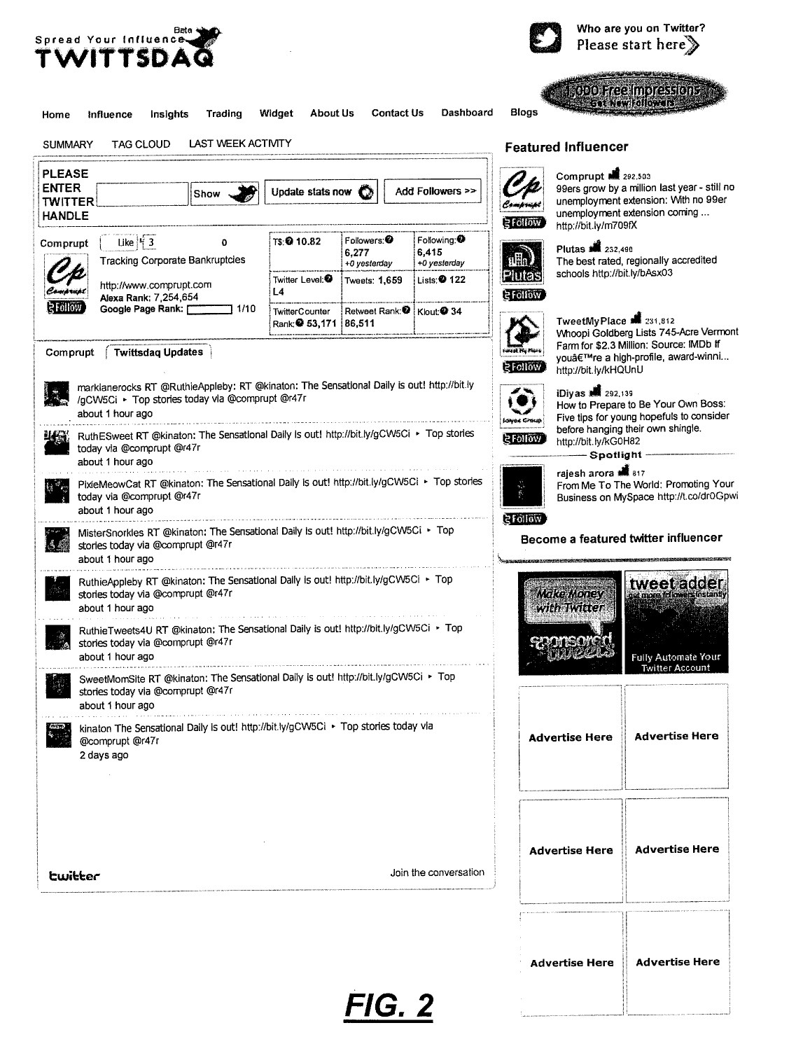

During use, a user may access the system 10 through a domain name, such as www.twittsdaq.com as illustrated in FIG. 2. The home page allows the user to log into the system with their user name and password. Again, this is the same username and password the user utilizes when logging into their Twitter® account. Alternatively, the user, when revisiting the site, is already logged in because the system 10 recognizes the user as a returning user. Once the user is logged in, the influence of the user is calculated using the above calculation, since the number of followers, following, and lists is fluid and constantly changes.

Once logged in, the user is allowed to buy and sell shares of public users using a dollar amount determine by a calculation designed to determine influence in a quantifiable number. The dollar amount is a twittsdaq dollar T$. From the home page, the user may click a link for the trading page to open. Once the trading page is opened, a number of user profiles with their share value may be displayed. In addition to or in lieu of, a user may enter a Twitter® name and the user profile is displayed with the number of shares available with the ask price, indicating the amount of twittsdaq dollars the required to purchase a share of the user profile. If the user desires to purchase a share or shares of the user profile, the user clicks a buy button and the transaction is automatically processed by the system and the twittsdaq dollars are automatically deducted from the total.

During use, a user may wish to sell certain shares of a user profile they own. Selling the shares involves the user clicking the sell link associated with the user profile and entering the number of shares the user is willing to sell. Once the shares have been sold to another user, the amount the shares purchased is automatically added to the user's twittsdaq dollar amount.

In another alternative embodiment, the system 10 allows a user to search Twitter® user profiles based upon either the amount of followers or the influence calculation. In other words, the user may search for user profiles that have a certain amount of influence based upon the calculation set forth above or based upon the number of followers. For example, a user may perform a search of Twitter® user profiles that have over 125,000 followers. This allows the user to view Twitter® user profiles of individuals or entities that have a large amount of influence. Additionally, the user may also search using search terms or hash tags in conjunction with limiting the search results to user profiles that have a certain amount of influence based upon the calculation set forth above or based upon the number of followers.

In another alternative embodiment, the system 10 is designed to be used by any number of individuals, i.e. the users 30. The system 10 is designed for use with the facilitation and expediting the sale of goods or services. The system 10 is designed to be used by a seller of these goods and provider of these services for placement of their goods and services for sale. The system 10 is designed to allow a buyer to search for goods and services for sale by sellers with high influence to ensure the seller is a reputable seller. The system 10 is fast, effective, and efficient.

Both the seller and buyer must register with the system 10 and log into the system upon each visit. The seller may log in using their social media password and username and as a result the sellers social media profile will be available to viewing by the buyers. In the present invention, the influence of the sellers is also calculated. The system 10 through the sever 12 calculates the influence of each seller. The influence is calculated as the difference between the number of followers and the number following, plus 10 times list and divided by the decay factor as described above.

[(# followers−# following)+10×list]/decay factor

Influence is based upon this equation. In other words, influence is created whenever the number of followers is greater than the number following plus 10 times list. The list is defined as the number of Twitter® lists containing this profile. This is positive influence, and like wealth, one has to work hard to earn it. Influence is defined on the system 10 as a Twittsdaq dollar (T$). In other words, the influence calculated by the system 10 is then assigned a number in monetary form and called a Twittsdaq dollar (T$). Each follower is assumed to be worth approximately T$0.01.

During use, the seller the system 10 presents to a seller a general category list of items and/or services the seller might be offering to a willing buyer. The general category list is a predetermined list of goods and/or services that are commonly bought, sold, and requested by a buyer and seller. The seller is not strictly limited to the goods and/or services found within the predetermined list, but may also add additional items should the good or service offered by the seller be absent from the predetermined list. The good or service may be added by simply entering the good or service description into an appropriate area positioned on the general category list.

Once the seller has identified the good and/or service, a separate window appears that allows the seller to enter information they believe to be the most important characteristics. The characteristics may fall into two categories. The first category being ordinal attributes. The ordinal attributes may be any preselected attribute, but preferably, the ordinal attributes represent key components of the good or service offered by the seller. For example, the ordinal attribute of a computer could be the amount of RAM, number of disk drives, speed of the CPU and the like. The second category is non-ordinal attributes. The non-ordinal attributes may be considered secondary attributes when compared to the ordinal attributes. Utilizing the above example, non-ordinal attributes for a computer may be the manufacturer of the CPU, the brand of computer, and the type of display (CRT or flat screen). Preferably, the seller may identify as many characteristics as desired, but only from sellers that have the requested level of influence or higher.

In addition to the description of the goods and/or services, the seller may list a requested price. The requested price may be listed in any currency or multiple currencies. For example, a European seller may list the price in euros and United States dollars. Alternatively, the list price may be in Euros and the system may automatically convert the euro into other worldwide currencies. Further, the system may change the currencies daily based upon market fluctuations. The seller may also list an expiration date. This date would indicate when the offer has expired and the item will be delisted from the system if not sold by the expiration date.

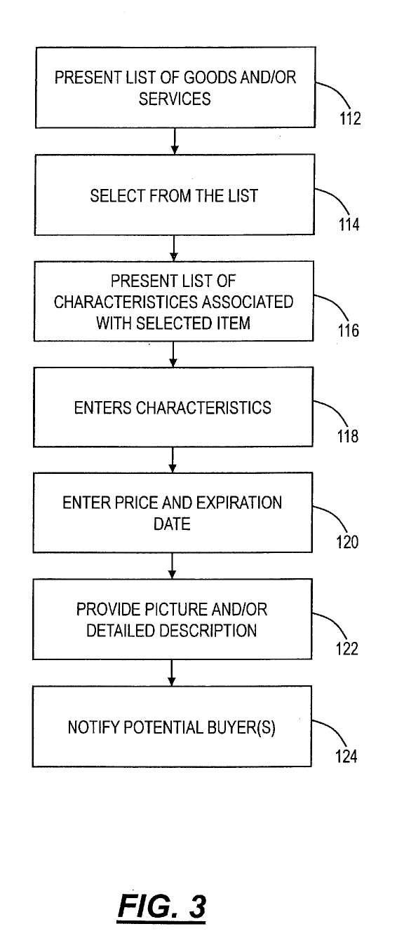

As illustrated in FIG. 3, the system 10 presents the seller with a list of goods and/or services from a predetermined list that the seller may sell within the system 10 (step 112), including the influence of the seller. The seller then selects the good or service they wish to sell from the list of goods and/or services (step 114). After the selection is made, the seller is then presented with a list of characteristics for the good or service the seller is offering (step 116). The list of characteristics also includes a range of values for each characteristic. These characteristics may be ordered so they are ordinal attributes and other characteristics cannot be ordered so they are non-ordinal attributes. The list of characteristics may be based upon a predetermined list of characteristics for a certain item. The list of characteristics may also be fluid in that the list of characteristics may include characteristics other sellers have identified for the good or service. In other words, should a seller enter a characteristic on the list of characteristics not previously predetermined, the characteristic is automatically added as an option for a future seller to select on the list of characteristics.

Preferably, the seller may identify as many characteristics as they wish (step 118). Should a characteristic not be located on the list of characteristics, the seller may add the characteristic in the list of characteristics. The seller then may enter values for all of the characteristics of the good or service on the list of values. After the values are entered into the list of values the seller may enter a price they will accept for the goods or services (step 120). The price will be treated as an ordinal characteristic. An expiration date may be listed by the seller. As mentioned above, if the good or service is not sold by the expiration date, the good or service is delisted from the system. To further enhance the possibility of selling their item, the seller may upload a picture, photograph, or detailed description of the good or service they are placing for sale (step 122).

The system 10 allows the seller to be notified when a potential buyer is interested in the good or service they are attempting to sell (step 124). The notification may be sent to the seller in any form that is acceptable. Preferably, the notification is by email, text message, phone call or the like. The seller may also receive notification by more than one method. For example, the seller may receive a notification by email and text message.

When the buyer accesses the system, the buyer is presented with a list of goods or services currently offered for sale within the system. The buyer then selects a good or service from the list they are interested in purchasing. Once the buyer selects the good or service, a characteristics list is presented, which allows the buyer to select characteristics they desire for the goods or services they want to purchase. The buyer also sets a range of values for each characteristic. The characteristics may fall into two categories. The first category being ordinal attributes. The ordinal attributes may be any preselected attribute, but preferably, the ordinal attributes represent key components of the good or service offered by the seller. For example, the ordinal attributes of a computer could be the amount of RAM, number of disk drives, speed of the CPU and the like. The second category is non-ordinal attributes. The non-ordinal attributes may be considered secondary attributes when compared to the ordinal attributes. Utilizing the above example, non-ordinal attributes for a computer may be the manufacturer of the CPU, the brand of computer, and the type of display (CRT or flat screen). Preferably, the buyer may identify as many characteristics as they would like.

The system 10 allows a buyer to select characteristics that are appealing to them for their desired need. If the characteristic is ordinal (e.g the number of cpu's for the purchase of a computer) the system 10 is designed so that any values close to the selected values may be considered by the value. In other words, the buyer may select the number 2 for the number of cpus, since the characteristic is ordinal and the system is programmed to understand that the number 3, representing 3 cpus, is close to the desired 2 cpus in the match list that could potentially contain 3 cpus.

If the characteristic is non-ordinal (e.g the manufacturer of the cpu) the system is not designed to recognize how INTEL®, AMD®, ACME Super CPU, etc. relate and will be forced to discard computers that match all characteristics except the non-ordinal cpu manufacturer characteristic. All characteristics are a perfect match except the cpu manufacturer and the computer would not appear in the match list. In reality, buyers that select Intel® for a cpu manufacturer may consider AMD® if all other characteristics match. This characteristic is non-ordinal so the system will not know how to select values that are close to the preferred value. The system allows buyers to select values for non-ordinal characteristics that they will accept and then identify the one value for non-ordinal characteristics that are the preferred value. This would allow computers to be listed in the match list if they match on all characteristics except a non-ordinal preferred value.

The buyer may enter values for the characteristics they would like the matching algorithm to consider. For each characteristic presented, the buyer may choose a value based upon the needs and wants of the buyer. For non-ordinal characteristics, the buyer may identify if the value is selected is the preferred value. The buyer is also able to limit the results returned based upon the influence of the seller.

The buyer may list any price range they would consider purchasing the good or service. The price range entered by the buyer would be treated as an ordinal characteristic for matching purposes. The buyer may also list an offer expiration date indicating that if the buyer fails to purchase the good or service by the expiration date, the system will cease looking for goods and services the buyer is interested in purchasing.

Once the buyer has entered the goods or services they are interested in purchasing and completely entered the characteristics, price range, and/or expiration date, the system begins searching for goods or services for sale matching the criteria entered by the buyer. The system searches for these goods or services by utilizing a matching algorithm that creates a match score. The match score is used to select goods or services for sale using the characteristics entered by the buyer. The goods or services located that match the criteria of the buyer are sorted by the match score and presented to the buyer. In other words, the system uses the match score to locate the most relevant goods or services based upon the desired characteristics of the buyer. The system presents the buyer with the goods or services in order of importance based upon the desired characteristics.

The matching algorithm uses the ranges of values for ordinal characteristics and binary flags for non-ordinal characteristics. For numeric ordinal characteristics, the matching algorithm considers all goods or services for sale where the numeric ordinal characteristic value is within +/− a user definable percentage from the value identified by the buyer. The +/− percentage will default to a definable level but the default level can be overridden if the buyer sets a specific +/− percentage level. The absolute value of the percent different difference between the buyer's preference and the characteristic entered by the seller is added to the match score. By way of example only, if the value entered by the seller is 110% of the value entered by the buyer, the matching algorithm will add 10 to the match score.

For non-ordinal characteristics, the matching algorithm considers all goods for sale that are within +/− a user definable number of categories from the value identified by the buyer. If the category selected by the buyer exactly matches the category entered by the seller, the matching algorithm adds zero to the match score. The matching algorithm adds different amounts to the match score depending on how many categories separate the value selected by the buyer and entered by the seller. For example, if the buyer has selected the term “teen age” from the characteristics list and the seller has entered “young adult.” The matching algorithm might add 10 to the match score. By way of another example, if the buyer selects the term “senior” and the seller has entered “young adult,” the matching algorithm would add 20 to the match score. If the buyer selects multiple levels, the matching algorithm will consider the levels selected to be absolute and be limited to the specific levels the buyer has selected. Zero will be added to the match score.

For non-ordinal characteristics, the matching algorithm considers the buyer's selection of preferred or absolute. If the buyer has selected preferred for the value the matching algorithm mad add zero to the match score for all items for sale where the values exactly match and the matching algorithm may add 10 to the match score for all items that do not exactly match what the buyer has selected. If the buyer has selected absolute for the value, the matching algorithm does not consider any items wherein the match for the characteristic is not exact.

The matching algorithm evaluates all characteristics identified by the buyer as being important and sums all match score adjustments to create the final score. The items for sale are rank ordered by the match score and a user definable number of best matches are displayed for the buyer with low values at the top of the list.

The buyer may also adjust the criteria upon initially receiving the results from the system. The buyer can easily adjust the values for all characteristics they would like used for the match. The buyer can also add or delete characteristics from the matching process. Once the buyer has adjusted the characteristics, the matching algorithm reevaluates all the characteristics identified by the buyer as being important and sums all match score adjustments to recreate the final match score. The list of items produced by the system changes in accordance with the buyer's adjustment in a manner that is very intuitive for the buyer. This enables the buyer to understand how their selection of characteristics and specific values for characteristics affect the list of matching goods and services.

In addition to adjusting the criteria, the buyer may enter relative importance values for each of the characteristics they would like to be used in the matching process. For example, the buyer may rank characteristics between 1 and 5, with 1 being the most important and 5 being the least important. Multiple characteristics may be assigned the same relative importance. When the matching algorithm creates the match score, the component values for all items with relative importance of 1 are multiplied by 10, 2 are multiplied by 7.5, 3 are multiplied by 5, 4 are multiplied by 2.5, and 5 are multiplied by 1. This will influence the match score to be higher for items with relative importance of 1 that are not exact matches.

When the buyer selects a good or service provided by the system from a match list, a web page is displayed that contains photographs or goods and detailed descriptions of services. The information displayed will probably include geographic location and potential shipping costs. Items that cannot be shipped will be identified as “pick up only.” If the seller has multiple items listed for sale, the buyer is able to view the goods or services of the seller by clicking on a link or the like.

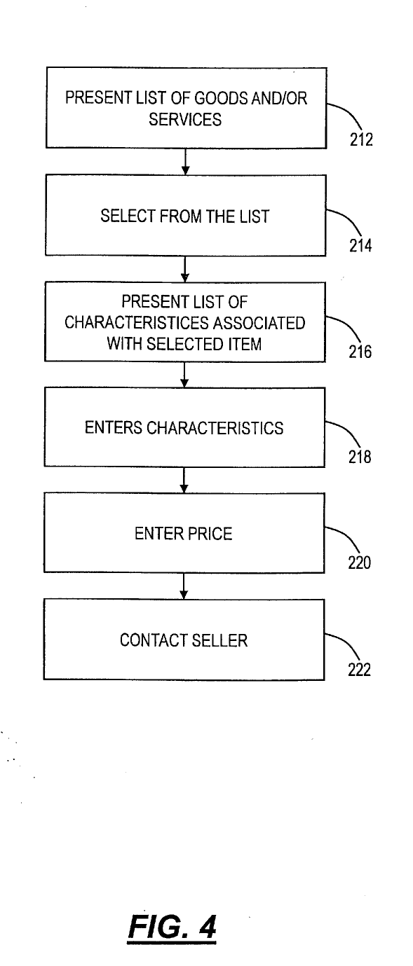

As illustrated in FIG. 4, the system 10 presents the buyer with a general list of goods and/or services currently offered for sale within the system 10 (step 212). The buyer then selects the good or service they are interested in purchasing from the list of goods and/or services (step 214). After the selection is made, the buyer is then presented with a list of characteristics for the good or service the seller is offering (step 216). The list of characteristics also includes a range of values for each characteristic. These characteristics may be ordered so they are ordinal attributes and other characteristics cannot be ordered so they are non-ordinal attributes. The list of characteristics may be based upon a predetermined list of characteristics for a certain item.

Preferably, the buyer may identify as many characteristics as they wish. The buyer then may enter values for all of the characteristics of the good or service on the list of values (step 218). After the values are entered into the list of values the buyer may enter a price they will pay for the goods or services (step 220). The price will be treated as an ordinal characteristic. An expiration date may be listed by the buyer. As mentioned above, if the good or service is not purchased by the expiration date, the good or service is delisted from the system 10.

The system 10 allows for the seller and buyer to communicate with each other (step 222). The buyer may select goods or services on the list presented by the matching algorithm to open a dialog with the seller. The buyer may then post messages for the seller. The seller and buyer can select the preferred method of receiving notification from the other. The choices include email, text message, phone call, or the like. The buyer has the option to select multiple notification methods. When a dialog is requested with a seller for a specific good or service the seller is notified and responds to any messages from a potential buyer or multiple potential buyers. The seller is then notified when the buyer responds to their message.

The email messages between the buyer and seller contain a complete email chain of all messages sent between a like seller and like buyer. The emails may only be viewed by the buyer and the seller, and are not publically available. The email message has a look very similar to known emails, but the email does not contain the correct, visible email address of either the seller or the buyer. The emails go to a system, and then, the system forwards them to the appropriate address. With this communication format, the seller and buyer do not have to log into the system to read messages. They simply communicate with each other as if the system was not acting as an intermediary. Essentially, the system facilitates email communication between buyers and sellers so the individuals can interact as if they had email addresses for each other. The system does not require individuals to adopt a new email communication process.

In summary, the email communication process of the system begins when an email is sent that includes the complete dialog concerning the specific good or service. If this is the first email to the buyer with an initial message from a buyer, it includes the message keyed into the system by the buyer. When an email is received, the new portion of the email message is automatically entered into the system as if the message had been keyed directly into the system by the buyer and seller. If the buyer or seller log into the system and type a message directly into the system, that message is included in the email sent to the other individual so the dialog is complete. The individual that receives the email will not know if the other individual responded to an email or if they logged into the system and typed the message directly into the system. They seller and buyer may be notified when the other party responds to a message. The notification methods include email, text message, phone call, or the like. The message received simply notifies the buyer or seller that the other party has responded to their prior message. The notification method does not contain a record of the dialog, but informs the buyer or seller of a response. The buyer or seller must log into the system to view the message and may respond to the message by typing a message into the system.

Once the buyer has decided to purchase a good or service from the seller, the seller may log into the system to indicate agreement and the transaction processing capability becomes available for the buyer to pay the seller. Alternatively, when the seller responds to the buyer that they agree to the terms, the seller may enter specific terms or codes into the email response that the system reads and automatically enables the transaction processing capability. The dollar amount for the transaction is set by the seller either by logging into the system or using specific terms or codes in the email message. The buyer logs into the system and initiates the transaction for the amount agreed to and is already shown in the system. The system receives the money, deducts a system fee, and then sends the rest of the money to the seller. When the seller receives the money, they ship the good to the buyer or initiate providing the service.

When a buyer does not locate a desired good or service on the system, the buyer may be notified when a desired good or service is offered by a seller on the system. The desired good or service is based upon the match score calculated by the matching algorithm as set forth above. The buyer may select different values for the match score and the system will then show them the exact goods or services currently listed for sale that meet the criteria. By examining the goods or services on the list using different match score values, the buyer can select a value for the match score they would like to have used for notifications of new goods or services listed for sale. The buyer does not need to know they are selecting a value for the match score. Instead, the system can present the match score as a value from 1 to 100 where the buyer believes they are selecting from a percent match with higher percent match values being associated with lower match scores. The concept of match score may confuse many users of the system. The buyer may set a date at which they would like the notifications to cease.

During use, as sellers list additional items and services for sale, the match score for all buyers have requested notification for the specific item is calculated. If the match score is within the match threshold set by the buyer, the buyer is notified.

The system allows a buyer to rate a seller, and a seller to rate a buyer. The rating system is based upon the quality of the transaction. The rating system is to instill a level of confidence in the buyer that the seller is reputable, assuming the seller has been given positive rankings The buyer is ranked also to provide information to a seller about the buyer. This allows sellers to gain knowledge of the payment history of the buyer. Both buyers and sellers can review all rankings given to each other.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A method of electronic trading, comprising:
providing a server and at least one user terminal that is coupled to the server, a first user having a first user profile and a plurality of second users having a plurality of second user profiles;
accessing a social media platform of the first user with the at least one user terminal;
calculating influence of the user and providing a quantity of trading currency for use by the first user;
calculating influence of the second user profiles and assigning a quantity of trading currency to the second user profiles based upon the calculated influence; and
buying shares of the second user profiles by the first user.

2. The method of electronic trading of claim 1, further comprising the first user profile that contains a quantity of followers, a quantity of user's following, a list and calculating the difference between quantity of followers and the quantity following, plus 10 times list and divided a decay factor.

3. The method of electronic trading of claim 1, wherein the social media platform is Twitter®.

4. The method of electronic trading of claim 1, further comprising the first user offering to sale shares electronically to a third user.

5. The method of electronic trading of claim 1, further comprising accessing the server by inputting the username and password of the social media platform.

6. A method searching based upon influence, comprising:
providing a server and at least one user terminal that is coupled to the server, a first user having a first user profile and a plurality of second users having a plurality of second user profiles;
accessing a social media platform of the first user with the at least one user terminal;
calculating influence of the second user profiles and assigning a quantity of trading currency to the second user profiles based upon the calculated influence;
submitting a first search query for searching a first level database that yields high level aggregated classifications;
obtaining high level aggregated classifications based upon the first search query;
submitting a second search query based upon the high level aggregated classifications of the first search query;
ranking results of the second search query based upon the calculated influence; and
obtaining focused results based upon the second search query.

7. The method of electronic trading of claim 6, further comprising providing a database of stored search terms and pages.

8. The method of electronic trading of claim 6, further comprising submitting a third search query based upon the focused results based upon the second search query.

9. The method of electronic trading of claim 6, further comprising submitting an expiration date for removing results from a search.

10. The method of electronic trading of claim 6, further comprising submitting a detail description for inclusion with the results from the search.

11. The method of electronic trading of claim 6, further comprising submitting a rank based upon experiences encountered during the search.

12. A system for electronic trading based upon influence, comprising:
a local interface;
a data store;
a server;
at least one user terminal; and at least one user terminal that is coupled to the server, a first user having a first user profile and a plurality of second users having a plurality of second user profiles
a processor coupled to the local interface, the data store, the server, and the at least one user terminal, wherein the processor is configured to access a social media platform of a first user with the at least one user terminal, calculate influence of the first user, provide a quantity of trading currency for use by the first user, calculate influence of a plurality of second user profiles and assigning a quantity of trading currency to the second user profiles based upon the calculated influence, and buy shares of the second user profiles by the first user based upon the trading currency and the calculated influence.

13. The system for electronic trading based upon influence of claim 12, further comprising memory that may be accessed by the processor.

14. The system for electronic trading based upon influence of claim 12, further comprising the first user profile that contains a quantity of followers, a quantity of user's following, a list and calculating the difference between quantity of followers and the quantity following, plus 10 times list and divided a decay factor.

15. The system for electronic trading based upon influence of claim 12, wherein the social media platform is Twitter®.
